(19) United States
(12) Patent Application Publication
(10) Pub. No.: US 2023/0223662 A1
(43) Pub. Date: Jul. 13, 2023

(54) Secondary Battery and Welding Method Thereof

(71) Applicants: REPT BATTERO Energy Co., Ltd., Wenzhou (CN); Shanghai Ruipu Energy Co., Ltd., Shanghai (CN)

(72) Inventors: Hui CAO, Wenzhou (CN); Xianfeng YU, Wenzhou (CN); Wenming GAO, Wenzhou (CN); Xingdong WANG, Wenzhou (CN); Min HOU, Shanghai (CN); Zhaoyu YU, Wenzhou (CN)

(21) Appl. No.: 18/095,388

(22) Filed: Jan. 10, 2023

(30) Foreign Application Priority Data
Nov. 12, 2021 (CN) 202122772633.2
Nov. 29, 2022 (CN) 202211507675.6
Nov. 29, 2022 (CN) 202211507691.5

(51) Int. Cl. H01M 50/536; H01M 50/538

(52) U.S. Cl. CPC H01M 50/536; H01M 50/538

(57) ABSTRACT

The present disclosure proposes a secondary battery and welding method thereof. The secondary battery comprising a top cover, a pole, a cell and a transfer sheet, wherein the pole comprising a first pole, which being provided in the top cover; the cell comprising a first cell, the first cell leading out a first tab and a second tab with opposite polarity; the transfer sheet comprising a first transfer sheet, the first transfer sheet electrically connecting the first tab to the first pole; wherein the first transfer sheet having a first surface and a second surface oppositely, the first tab and the first transfer sheet being connected in any of the following two ways: a part of tabs of the first tab being connected to the first surface, other part of tabs of the first tab being connected to the second surface, the first transfer sheet being located between the part of tabs of the first tab and the other part of tabs of the first tab, or, all tabs of the first tab being connected to the first surface of the first transfer sheet.

### TECHNICAL FIELD

This present disclosure relates to the field of battery technology, specifically relates to a secondary battery and welding method thereof.

### BACKGROUND

At present, tab of cell and pole of top cover of secondary battery is welding connected by transfer sheet. For example, one or multiple tabs of cell are gathered as a whole and then sandwiched between two layers of transfer sheets for welding connection, or, one or multiple tabs of cell are gathered as a whole and then set on a single surface of upper surface or lower surface of the transfer sheet for welding connection. Both of the two ways are first gathering one or multiple tabs of cell into a whole and then welding connection with the transfer sheet, in the process of bending and gathering tabs after the welding connection, the path of each layer of the gathered tab from the outer layer to the inner layer or from the inner layer to the outer layer to the transfer sheet welding connection part is inconsistent and long, the length of tab of cell will also be very long, which is easily to cause the loose and tight state of each layer tab to be different, from the outer layer to the inner layer or from the inner layer to the outer layer, from very tight to very loose state of stress or from very loose to very tight state of stress. Tab in the outer layer part or inner layer part which is very tight is easy to be broken causing problems such as reduced overcurrent capacity of the tab of cell and short circuit of the cell. Tab in the inner layer part or outer layer part which is very loose is easy to insert into the inside of the cell and contact with the cell sheet resulting in short circuit of the cell and other problems. Therefore, this way of connecting and fixing for the tabs of cell with the transfer sheet is easy to cause safety risk problems such as short circuit of the cell.

In addition, when welding the above mentioned transfer sheet and tabs, it is necessary to set a large space between the cell and the top cover, which leads to poor space utilization inside the battery, and the tabs provided in the bottom of the transfer sheet near the side of the cell is prone to the phenomenon of tab redundancy.

### SUMMARY

The present disclosure proposes a secondary battery comprising a top cover, a pole, a cell and a transfer sheet, wherein the pole comprising a first pole, which being provided in the top cover; the cell comprising a first cell, the first cell leading out a first tab and a second tab with opposite polarity; the transfer sheet comprising a first transfer sheet, the first transfer sheet electrically connecting the first tab to the first pole; wherein the first transfer sheet having a first surface and a second surface oppositely, the first tab and the first transfer sheet being connected in any of the following two ways: a part of tabs of the first tab being connected to the first surface, other part of tabs of the first tab being connected to the second surface, the first transfer sheet being located between the part of tabs of the first tab and the other part of tabs of the first tab, or, all tabs of the first tab being connected to the first surface of the first transfer sheet.

The present disclosure also proposes a welding method for a secondary battery, the secondary battery comprising a cell and a transfer sheet, the welding method comprising the following steps: sucking at least one tab of a tab set of the cell using a suction nozzle so that the tab set being divided into two tab layers along the thickness direction of the cell, wherein the cell having at least one tab set, and each tab set including at least two tabs; and welding the transfer sheet between two layers of the tab layer.

The present disclosure also proposes a welding method for a secondary battery, the secondary battery comprising a cell, a transfer sheet, a top cover and a pole, wherein the pole comprising a first pole, which being provided in the top cover; the cell comprising a first cell and a second cell, the first cell and the second cell being adjacent in the thickness direction of the secondary battery, tab set of the first cell and tab set of the second cell being adjacent in the thickness direction and forming a combined tab set; the welding method comprising steps: sucking at least one tab of the combined tab set using a suction nozzle, such that the combined tab set being divided into two layers of the tab layer along the thickness direction; and welding the transfer sheet between two layers of the tab layer in the combined tab set.

### BRIEF DESCRIPTION OF THE DRAWINGS

The features and performance of the present disclosure are further described by the following embodiments and their accompanying drawings.

FIG. 1 is a front view of the connection between tabs and transfer sheet in embodiment 1 of the present disclosure;

FIG. 2 is a top view of the connection between tabs and transfer sheet in embodiment 1 of the present disclosure;

FIG. 3 is a bottom view of the connection between tabs and transfer sheet in embodiment 1 of the present disclosure;

FIG. 4 is the structure diagram 1 of the connection between tabs after bending and transfer sheet in embodiment 1 of the present disclosure;

FIG. 5 is the structure diagram 2 of the connection between tabs after bending and transfer sheet in embodiment 1 of the present disclosure;

FIG. 6 is a structure diagram of the connection between tabs after bending and transfer sheet in embodiment 2 of the present disclosure;

FIG. 7 is a structure diagram of the connection between tabs after bending and transfer sheet in embodiment 3 of the present disclosure;

FIG. 8 is a front view of the connection between tabs and transfer sheet in embodiment 4 of the present disclosure;

FIG. 9 is a structure diagram of the connection between tabs after bending and transfer sheet in embodiment 4 of the present disclosure;

FIG. 10 is a structure diagram of the connection between tabs after bending and transfer sheet in embodiment 5 of the present disclosure;

FIG. 11 is a front view of the connection between tabs and transfer sheet in embodiment 6 of the present disclosure;

FIG. 12 is a top view of the connection between tabs and transfer sheet in embodiment 6 of the present disclosure;

FIG. 13 is a bottom view of the connection between tabs and transfer sheet in embodiment 6 of the present disclosure;

FIG. 14 is a front view of the connection between tabs and transfer sheet in embodiment 7 of the present disclosure;

FIG. 15 is a top view of the connection between tabs and transfer sheet in embodiment 7 of the present disclosure;

FIG. 16 is a front view of the connection between tabs and transfer sheet in embodiment 8 of the present disclosure;

FIG. 17 is a top view of the connection between tabs and transfer sheet in embodiment 8 of the present disclosure;

FIG. 18 is a top view of the connection between tabs and transfer sheet in embodiment 9 of the present disclosure;

FIG. 19 is a schematic diagram representing the calculated relationship of the remaining space height of the folded tab;

FIG. 20 is a schematic diagram representing the height and thickness dimensions of tabs;

FIG. 21 is a structure diagram of tabs layering of the welding method of secondary battery of an embodiment of the present disclosure;

FIG. 22 is a structure diagram of tabs with changing dimension of the secondary battery of an embodiment of the present disclosure;

FIG. 23 is a structure diagram of the entering process of insertion rod of the welding method of secondary battery of an embodiment of the present disclosure;

FIG. 24 is a structure diagram of insertion rod entering into the space between two layers of tabs of the welding method of secondary battery of an embodiment of the present disclosure;

FIG. 25 is a structure diagram of insertion rod lifting tabs of the welding method of secondary battery of an embodiment of the present disclosure;

FIG. 26 is a structure diagram of transfer sheet entering into the space between two layers of tabs of the welding method of secondary battery of an embodiment of the present disclosure;

FIG. 27 is a placement diagram of two suction nozzles of the welding method of secondary battery of an embodiment of the present disclosure;

FIG. 28 is a placement diagram of multiple suction nozzles of the welding method of secondary battery of an embodiment of the present disclosure;

FIG. 29 is a structure diagram of suction nozzle channel of the welding method of secondary battery of an embodiment of the present disclosure;

FIG. 30 is a structure diagram of cell of the secondary battery of an embodiment of the present disclosure;

FIG. 31 is a structure diagram of positive/negative sheet under unwound state of the cell of FIG. 30;

FIG. 32 is a structure part diagram of the secondary battery of an embodiment of the present disclosure;

FIG. 33 is a schematic diagram of the process of performing the welding method of secondary battery of an embodiment of the present disclosure.

### PREFERRED EMBODIMENT OF THE PRESENT DISCLOSURE

The present disclosure is described in detail below in combination with specific embodiments. The following embodiments will assist those skilled in the art to further understand the present disclosure, but do not limit the present disclosure in any way. It should be noted that to a person of ordinary skill in the art, several variations and improvements can be made without departing from the conception of the present disclosure. These are within the scope of protection of the present disclosure.

One aspect of the present disclosure provides a secondary battery comprising a top cover, a cell 3, a pole 2 and a transfer sheet; the pole comprising a first pole, which being provided in the top cover; the cell comprising a first cell, the first cell leading out a first tab and a second tab with opposite polarity; the transfer sheet comprising a first transfer sheet, the first transfer sheet electrically connecting the first tab to the first pole; wherein the first transfer sheet having a first surface and a second surface oppositely, the first tab and the first transfer sheet being connected in any of the following two ways: a part of tabs of the first tab being connected to the first surface, other part of tabs of the first tab being connected to the second surface, the first transfer sheet being located between the part of tabs of the first tab and the other part of tabs of the first tab, or, all tabs of the first tab being connected to the first surface of the first transfer sheet.

The present disclosure does not limit the number of cells in a secondary battery. In some embodiments, the cell 3 includes a positive sheet, a negative sheet and a diaphragm, the diaphragm separates the positive sheet and the negative sheet. The positive sheet includes a positive sheet body and positive tabs protruding from the positive sheet body, and the negative sheet includes a negative sheet body and negative tabs protruding from the negative sheet body. The cell can be a winding structure or a laminating structure. Take the winding structure as an example, after the positive sheet, the negative sheet and the diaphragm are winding, the positive sheet body, the negative sheet body and the diaphragm form a body of the cell or a main body of the cell, at least one positive tab or multiple positive tabs partially or fully overlapped to form a positive tab of the cell, and at least one negative tab or multiple negative tabs partially or fully overlapped to form a negative tab of the cell. The following 9 embodiments are used to illustrate the secondary battery.

### Embodiment 1

The secondary battery of this embodiment includes a case, a top cover 1, a pole 2, a cell 3 and a transfer sheet 4. The case can be hexahedral shape or other shapes, and a case space is formed inside the case to accommodate the cell 3.

The top cover 1 is connected to the case and covers the opening of the case. As shown in FIG. 5, the top cover 1 has an opening to accommodate the pole 2, the pole 2 is mounted to the top cover 1 by a fixing member, and the top side of the pole 2 can be used to connect to the busbar.

As shown in FIG. 1, the cell 3 includes a main body and tabs extending from the main body, the tabs extending from the main body usually have a multi-layer laminating structure. Exemplarily, the tabs of the cell 3 extend from the upper side of the main body, and the cell 3 includes a first cell 31, a second cell 32, a third cell 33 and a fourth cell 34. In combination with FIG. 1 to FIG. 3, a first tab 311 and a second tab 312 with opposite polarity are led out from the first cell 31, a third tab 321 and a fourth tab 322 with opposite polarity are led out from the second cell 32, a fifth tab 331 and a sixth tab 332 with opposite polarity are led out from the third cell 33, and a seventh tab 341 and an eighth tab 342 with opposite polarity are led out from the fourth cell 34.

Exemplarily, there are two poles 2, the first tab 311, the third tab 321, the fifth tab 331, and the seventh tab 341 electrically connected to one of the poles 2, as the first pole shown in FIG. 5, and the second tab 312, the fourth tab 322, the sixth tab 332, and the eighth tab 342 electrically connected to the other pole 2, as the second pole (not shown in figures).

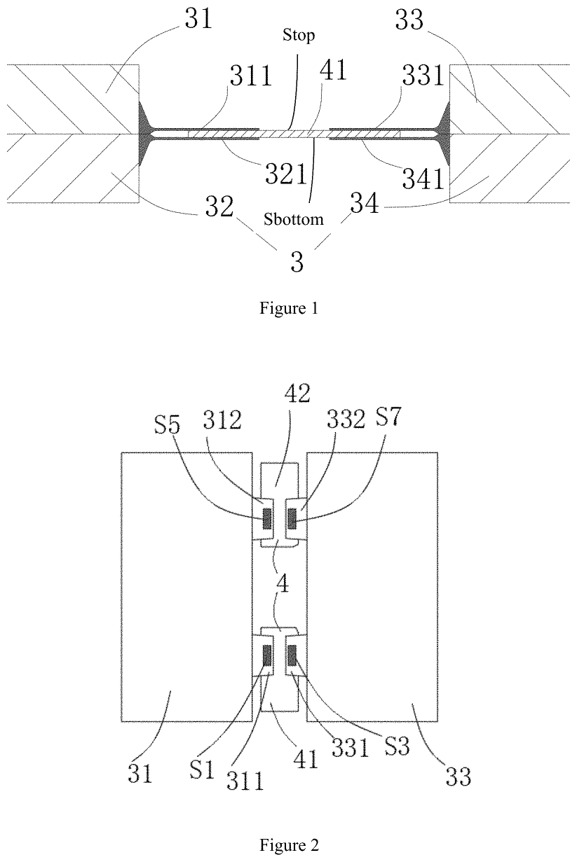

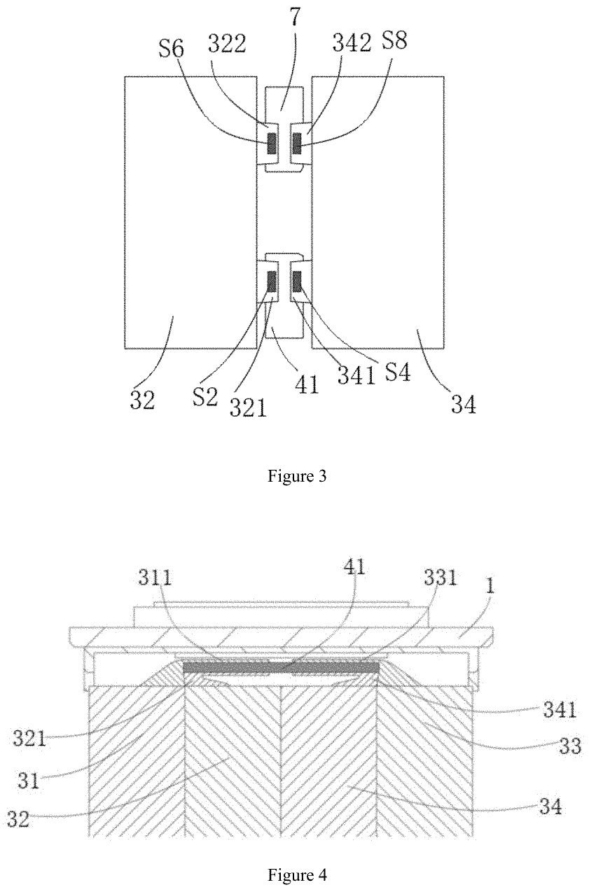

Specifically, the tabs leading out from the cell 3 are respectively welded to the surface of the transfer sheet 4, and the transfer sheet 4 is connected between the pole 2 and the tab of cell 3 to achieve the electrical connection of the tab and the pole 2. Exemplarily, the transfer sheet 4 includes a first transfer sheet 41 and a second transfer sheet 42, as shown in FIG. 2 and FIG. 3. The first tab 311, the third tab 321, the fifth tab 331, and the seventh tab 341 are electrically connected to the first pole by the first transfer sheet 41, the second tab 312, the fourth tab 322, the sixth tab 332, and the eighth tab 342 are electrically connected to the second pole by the second transfer sheet 42.

Taking the connection of the first transfer sheet 41 to the tabs of the cell 3 as an example, the transfer sheet 4 has a first surface and a second surface, in this embodiment, as shown in FIG. 1, for example, the first surface is upper surface Stop, and the second surface is lower surface Sbottom. It should be noted that the terms “top”, “bottom” or “left” and “right” mentioned in the present disclosure are not used to limit the actual orientation, but rather to indicate the relative direction. For example, in other embodiments, the first surface may also be a lower surface located below, and the second surface is an upper surface located above. In some conditions, the transfer sheet 4 may be in any position in space, the first surface facing in any direction in space, and the second surface being the opposite of the first surface. The use of words “first” and “second” in the present disclosure to limit the parts is only to facilitate the distinction of the corresponding parts, if not otherwise stated, the above words do not have a special meaning, and therefore cannot be understood as a limitation of the protection scope of the present disclosure.

Combined with FIG. 1 and FIG. 2, the first transfer sheet 41 and the second transfer sheet 42 are both substantially rectangular sheets, both having two relatively provided first side edges and two relatively provided second side edges, and the first side edge and the second side edge being adjacent to each other. For example, the first side edge is the long side of the rectangle, and the second side edge is the short side of the rectangle. As shown in FIG. 1, taking the first transfer sheet 41 as an example, the first tab 311 of the first cell 31 and the third tab 321 of the second cell 32 are connected to one side of the first transfer sheet 41, that is at the same first side edge, and, the first tab 311 is located at the upper surface Stop of the first transfer sheet 41, the third tab 321 is located at the lower surface Sbottom of the first transfer sheet 41; the fifth tab 331 of the third cell 33 and the seventh tab 341 of the fourth cell 34 are connected to the other side of the first transfer sheet 41, that is at the other first side edge, and, the fifth tab 311 is located at the upper surface Stop of the first transfer sheet 41, the seventh tab 341 is located at the lower surface Sbottom of the first transfer sheet 41. In other embodiments, the first tab 311 and the third tab 321 may be connected to a second side edge of the first transfer sheet 41, the fifth tab 331 and the seventh tab 341 may be connected to another second side edge of the first transfer sheet 41.

Combined with FIG. 2 and FIG. 3, tabs and transfer sheet form a connection area S, in one example, the first tab 311 and the first transfer sheet 41 form a first connection area S1, the third tab 321 and the first transfer sheet 41 form a second connection area S2, the positions of S1 and S2 are upper and lower opposite to each other. The fifth tab 331 and the first transfer sheet 41 form a third connection area S3, the seventh tab 341 and the first transfer sheet 41 form a fourth connection area S4, the positions of S3 and S4 are upper and lower opposite to each other.

Specifically, the connection method may be welding, and the connection area is also referred to as the welding area. In some embodiments, all tabs of the first tab 311 are welded to the upper surface of one side of the first transfer sheet 41, all tabs of the third tab 321 are welded to the lower surface of one side of the first transfer sheet 41, all tabs of the fifth tab 331 are welded to the upper surface of the other side of the first transfer sheet 41, and all tabs of the seventh tab 341 are welded to the lower surface of another side of the first transfer sheet 41.

Specifically, the first tab 311 and the third tab 321 may be connected to the first transfer sheet 41 synchronously, or may be connected to the first transfer sheet 41 individually and sequentially; the fifth tab 331 and the seventh tab 341 may be connected to the first transfer sheet 41 synchronously, or may be connected to the first transfer sheet 41 individually and sequentially.

Specifically, the above mentioned tabs may be welded to the first transfer sheet 41 by any one of at least one time of ultrasonic welding, laser welding, or a combination thereof.

In some embodiments, a protection sheet (not shown in figures) is also connected to the surface of the welding area of the transfer sheet 4.

In some embodiments, the connection of the second transfer sheet 42 to the tabs of the cell 3 may be same as the connection structure of the first transfer sheet 41 to the tabs of the cell 3. For example, all tabs of the second tabs 312 are welded to the upper surface of one side of the second transfer sheet 42, all tabs of the fourth tabs 322 are welded to the lower surface of one side of the second transfer sheet 42, all tabs of the sixth tabs 332 are welded to the upper surface of the other side of the second transfer sheet 42, and all tabs of the eighth tabs 342 are welded to the lower surface of another side of the second transfer sheet 42.

The second tab 312 and the second transfer sheet 42 form a fifth connection area S5, the fourth tab 322 and the second transfer sheet 42 form a sixth connection area S6, the positions of S5 and S6 are upper and lower opposite to each other; the sixth tab 332 and the second transfer sheet 42 form a seventh connection area S7, the eighth tab 342 and the second transfer sheet 42 form a eighth connection area S8, the positions of S7 and S8 are upper and lower opposite to each other.

The connection of the second transfer sheet 42 and the tabs of the cell 3 can also be different from the connection structure between the first transfer sheet 41 and the tabs of the cell 3 according to the actual design needs and circumstances, for example, the traditional connection method is still used.

As shown in FIG. 4 and FIG. 5, it shows the first cell 31, the second cell 32, the third cell 33 and the fourth cell 34 after the cell combination from different sides, and the connection state of the bending structure formed by the tabs of the cell 3 and the transfer sheet.

### Embodiment 2

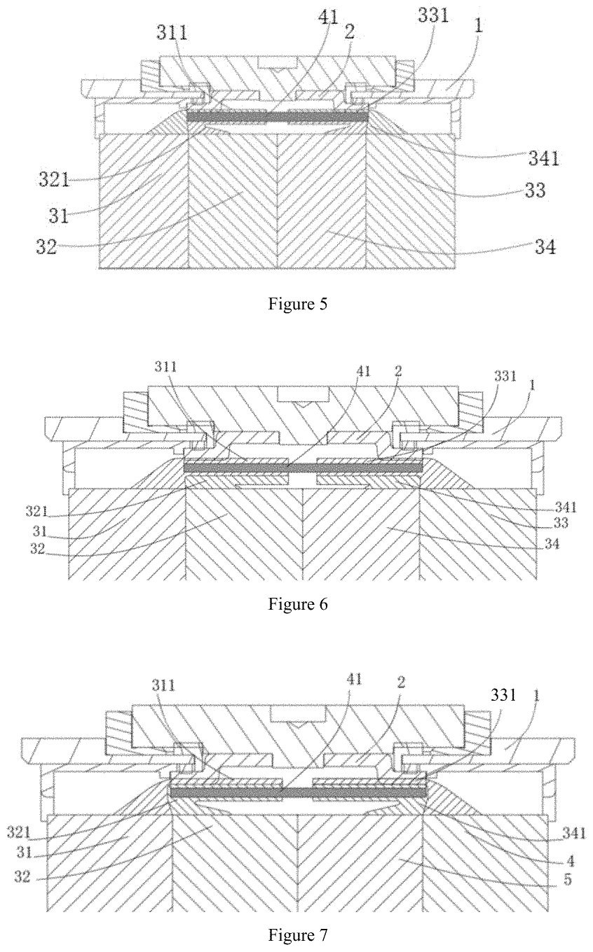

The same composition, structure and connection method of this embodiment 2 as in embodiment 1 will not be repeated here. As shown in FIG. 6, the thickness and/or number of layers of two parts of tabs on the upper surface and lower surface of the first transfer sheet 41 may or may not be equal.

Specifically, the first tab 311 includes a part of the first tab and the other part of the first tab, the fifth tab 331 includes a part of the fifth tab and the other part of the fifth tab; a part of the first tab is connected to the upper surface of one side of the first transfer sheet 41, and the other part of the first tab and the third tab 321 are connected to the lower surface of one side of the first transfer sheet 41.

In a specific connection method, a part of the first tab is connected to the upper surface of one side of the first transfer sheet 41 alone, the other part of the first tab and the third tab 321 may be connected to the lower surface of one side of the first transfer sheet 41 simultaneously, or, the other part of the first tab and the third tab 321 may be connected to the lower surface of one side of the first transfer sheet 41 independently and sequentially.

A part of the fifth tab is connected to the upper surface of the other side of the first transfer sheet 41, and the other part of the fifth tab and the seventh tab 341 are connected to the lower surface of the other side of the first transfer sheet 41.

In a specific connection method, a part of the fifth tab is connected to the upper surface of the other side of the first transfer sheet 41 alone, and the other part of the fifth tab and the seventh tab 341 may be connected to the lower surface of the other side of the first transfer sheet 41 simultaneously, or, the other part of the fifth tab and the seventh tab 341 may be connected to the lower surface of the other side of the first transfer sheet 41 independently and sequentially.

### Embodiment 3

The same composition, structure and connection method of this embodiment 3 as in embodiment 1 will not be repeated here. As shown in FIG. 7, the thickness and/or number of layers of two parts of tabs on the upper surface and lower surface of the first transfer sheet 41 may or may not be equal.

Specifically, the third tab 321 includes a part of the third tab and the other part of the third tab, the seventh tab 341 includes a part of the seventh tab and the other part of the seventh tab; the first tab 311 and a part of the third tab are connected to the upper surface of one side of the first transfer sheet 41, and the other part of the third tab is connected to the lower surface of one side of the first transfer sheet 41.

In a specific connection method, the other part of the third tab is connected to the lower surface of one side of the first transfer sheet 41 alone, the first tab 311 and a part of the third tab may be connected to the upper surface of one side of the first transfer sheet 41 simultaneously, or, the first tab 311 and a part of the third tab may be connected to the upper surface of one side of the first transfer sheet 41 independently and sequentially.

The fifth tab 331 and a part of the seventh tab are connected to the upper surface of the other side of the first transfer sheet 41, the other part of the seventh tab is connected to the lower surface of the another side of the first transfer sheet 41. In a specific connection method, the other part of the seventh tab is connected to the lower surface of the other side of the first transfer sheet 41 alone, and the fifth tab 331 and a part of the seventh tab may be connected to the upper surface of the other side of the first transfer sheet 41 simultaneously, or, the fifth tab 331 and a part of the seventh tab may be connected to the upper surface of the other side of the first transfer sheet 41 independently and sequentially.

### Embodiment 4

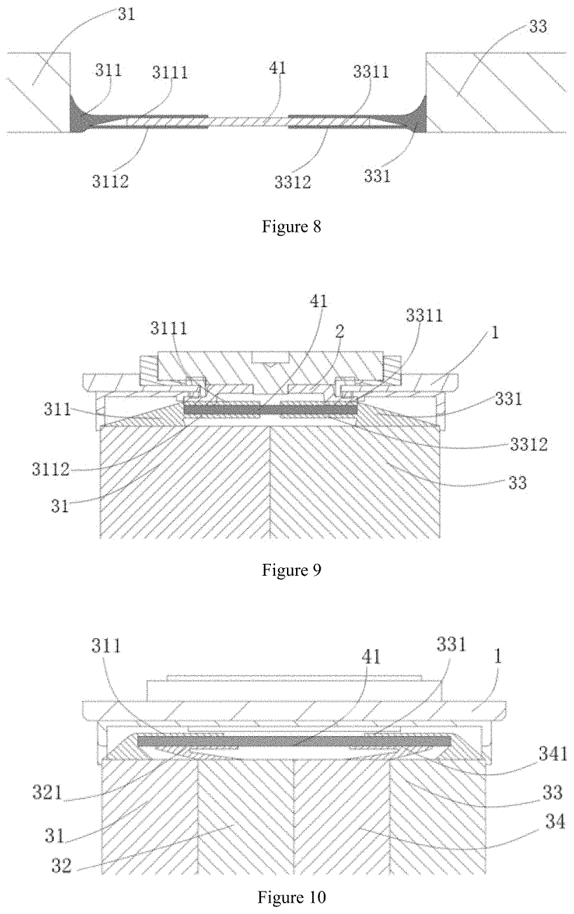

As shown in FIG. 8 and FIG. 9, the cell 3 includes a main body and tabs extending from the main body. Exemplarily, the cell 3 includes two cells that are the first cell 31 and the third cell 33.

Wherein, a first tab 311 and a second tab with opposite polarity are led out from the first cell 31 (not shown in figures), a fifth tab 331 and a sixth tab with opposite polarity are led out from the third cell 33 (not shown in figures).

Exemplarily, there are two poles 2, the first tab 311 and the fifth tab 331 electrically connected to one of the poles 2, the second tab and the sixth tab electrically connected to the other of the poles 2 (not shown in figures).

Specifically, the tabs leading from the cell 3 are respectively welded to the surface of the transfer sheet 4, and the transfer sheet 4 is connected between the pole 2 and the tabs of the cell 3 to achieve the electrical connection between the tabs and the pole. Exemplarily, the transfer sheet 4 includes a first transfer sheet 41 and a second transfer sheet (not shown in figures); the first tab 311 and the fifth tab 331 are electrically connected to one pole 2 by the first transfer sheet 41, and the second tab and the sixth tab are electrically connected to the other pole by the second transfer sheet.

As shown in FIG. 8 and FIG. 9, taking the connection of the first transfer sheet 41 to the tabs of the cell 3 as an example, the first tab 311 of the first cell 31 is connected to one side of the first transfer sheet 41, and the fifth tab 331 of the third cell 33 is connected to the other side of the first transfer sheet 41.

Further, the first tab 311 includes a first upper part tab 3111 and a first lower part tab 3112, the fifth tab 331 includes a fifth upper part tab 3311 and a fifth lower part tab 3312; the first upper part tab 3111 is connected to the upper surface of one side of the first transfer sheet 41, and the first lower part tab 3112 is connected to the lower surface of one side of the first transfer sheet 41; the fifth upper part tab 3311 is connected to the upper surface of the other side of the first transfer sheet 41, and the fifth lower part tab 3312 is connected to the lower surface of the other side of the first transfer sheet 41.

The other components, structures and connection methods are the same as those of embodiment 1 will not be repeated here.

### Embodiment 5

In the preceding embodiment, the tabs of the first cell 31 and the second cell 32 extend in opposite directions, that is as shown in FIG. 4, the tabs of the first cell 31 extend from the right side of the top surface of the first cell 31, and the tabs of the second cell 32 extend from the left side of the top surface of the second cell 32, both back-to-back. In embodiment 5, the first tab 311 is led out from the outer side of the first cell 31, and the third tab 321 is led out from the outer side of the second cell 32. Here the outer side refers to the side of the cell near the outer side of the secondary battery.

As shown in FIG. 10, the first cell 31 and the second cell 32 lead out tabs from the same outer side, which are both the left side. The third cell 33 and the fourth cell 34 lead out tabs from the same outer side, which are both the right side. When connected to the first transfer sheet 41, the tabs leading out from the first cell 31 and the second cell 32 are bent toward the inner side of the secondary battery, that is to the right, and the tabs leading out from the third cell 33 and the fourth cell 34 are bent toward the inner side of the secondary battery, that is to the left.

The cell 3 includes a first cell 31, a second cell 32, a third cell 33 and a fourth cell 34, side by side, wherein the first cell 31 leading out a first tab 311 and a second tab 312 with opposite polarity, the second cell 32 leading out a third tab 321 and a fourth tab 322 with opposite polarity, the third cell 33 leading out a fifth tab 331 and a sixth tab 332 with opposite polarity, and the fourth cell 34 leading out a seventh tab 341 and an eighth tab 342 with opposite polarity.

The first tab 311, the third tab 321, the fifth tab 331, and the seventh tab 341 are electrically connected to the first pole of the poles 2 by the first transfer sheet 41, the second tab 312, the fourth tab 322, the sixth tab 332, and the eighth tab 342 are electrically connected to the other pole of the poles 2 by the second transfer sheet 42, that is the second pole.

The first tab 311 of the first cell 31 and the third tab 321 of the second cell 32 are connected to one side of the first transfer sheet 41, and, the first tab 311 is located on the upper surface of the first transfer sheet 41, and the third tab 321 is located on the lower surface of the first transfer sheet 41; the fifth tab 331 of the third cell 33 and the seventh tab 341 of the fourth cell 34 are connected to the other side of the first transfer sheet 41, and, the fifth tab 331 is located on the upper surface of the first transfer sheet 41, the seventh tab 341 is located on the lower surface of the first transfer sheet 41.

Embodiment 5 is applicable to the secondary battery having transfer sheet with wider dimension, and the first tab 311 leading out from the outer side of the first cell 31 is provided. On one hand, compared with the first tab 311 leading from the inner side of the first cell 31, it can shorten the length of the first tab 311, and on the other hand, by setting the first connection area Si of the first tab 311 and the second connection area S2 of the third tab 321 in staggered position, for example, making the second connection area S2 closer to the pole 2, the current transmission path from the third tab 321 to the pole 2 is shortened, and the internal resistance of battery is reduced.

### Embodiment 6

On the basis of the above connection method between the tab and the transfer sheet, the connection between the tab and the transfer sheet is more flexible.

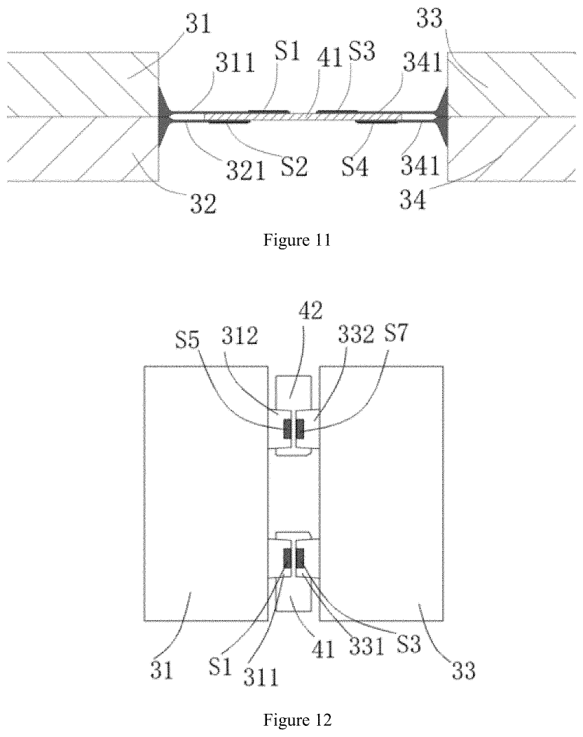

Specifically, as shown in FIG. 11, the length of the tabs of the cell 3 can not only use equal length tabs, but also can use unequal length tabs. The length of the first tab 311 is greater than the length of the third tab 321, thus to maintain the same tab tightness after combing the cell and bending the tab.

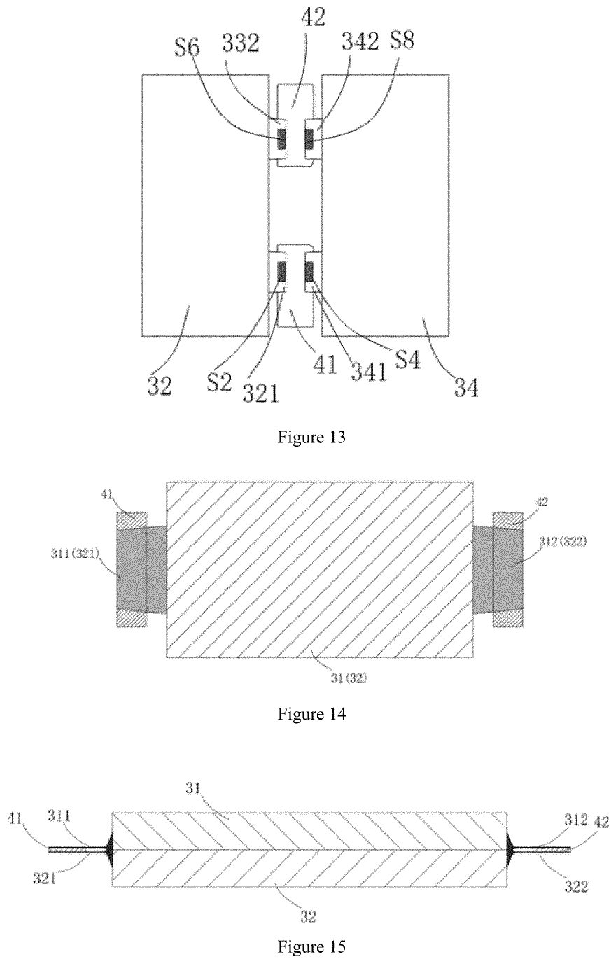

Specifically, tabs and transfer sheet form a connection area S, and in one example, as shown in FIG. 11 to FIG. 13, the first tab 311 and the first transfer sheet 41 form a first connection area S1, the third tab 321 and the first transfer sheet 41 form a second connection area S2, the positions of S1 and S2 staggered upper and lower. Referring to FIG. 20, the length of the first tab 311 is L1, and the length of the third tab 321 is L2, and L1 being greater than L2.

The fifth tab 331 and the first transfer sheet 41 form a third connection area S3, the seventh tab 341 and the first transfer sheet 41 form a fourth connection area S4, the positions of S3 and S4 staggered upper and lower. Make sure the tabs are connected tightly and maintain the tightness of all of the tabs consistently.

### Embodiment 7

As shown in FIG. 14 and FIG. 15, the cell 3 includes a main body and tabs protruding from the main body, and the tabs protruding from the main body typically have a multilayer laminated structure. Exemplarily, the tabs of the cell 3 protrude from the left side and right side of the main body.

The transfer sheet has a first surface and a second surface, in this embodiment, for example, the first surface is a front surface, and the second surface is a rear surface.

The cell 3 includes a first cell 31 and a second cell 32. The first cell 31 leads out a first tab 311 and a second tab 312 with opposite polarity, the second cell 32 leads out a third tab 321 and a fourth tab 322 with opposite polarity. As shown in FIG. 15, the first tab 311 and the second tab 312 are respectively located on the left side and right side of the main body of the first cell 31, the third tab 321 and the fourth tab 322 are respectively located on the left side and right side of the main body of the second cell 32. The first tab 311 is connected to the first surface of the first transfer sheet 41, and the third tab 321 is connected to the second surface of the first transfer sheet 41; the second tab 312 is connected to the first surface of the second transfer sheet 42, and the fourth tab 322 is connected to the second surface of the second transfer sheet 42.

### Embodiment 8

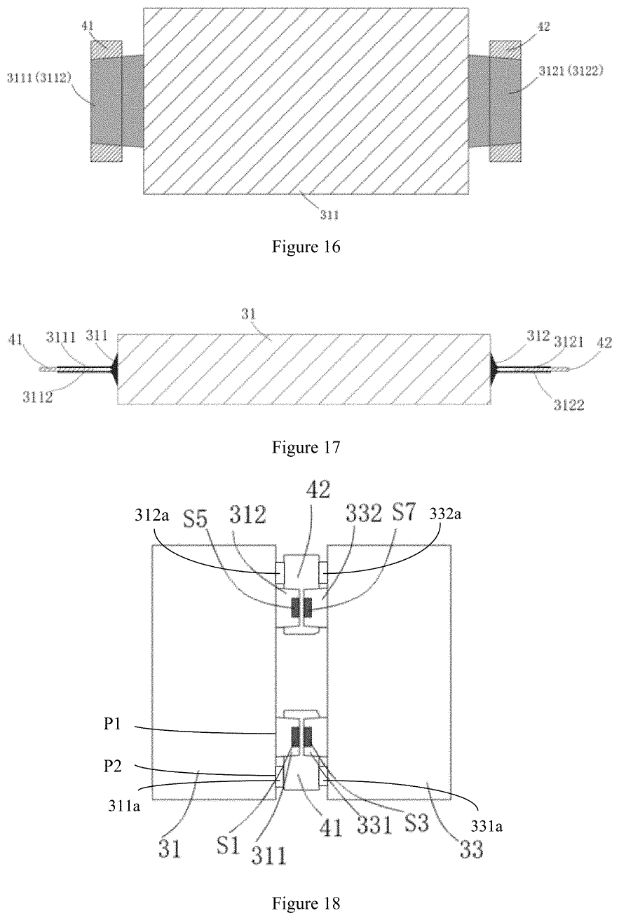

The same composition, structure and connection method in the present embodiment 8 as in embodiment 7 will not be repeated here. As shown in FIG. 16 and FIG. 17, the cell 3 includes a first cell 31.

The left and right sides of the main body of the first cell 31 respectively lead out a first tab 311 and a second tab 312 with opposite polarity. In some embodiments, all tabs of the first tab 311 are connected to the first surface of the first transfer sheet 41, and all tabs of the second tab 312 are connected to the first surface of the second transfer sheet 42. In other embodiments, as shown in FIG. 17, a part of the first tab 3111 is connected to the first surface of the first transfer sheet 41, and the other part of the first tab 3112 is connected to the second surface of the first transfer sheet 41; a part of the second tab 3121 is connected to the first surface of the second transfer sheet 42, and the other part of the first tab 3122 is connected to the second surface of the second transfer sheet 42.

### Embodiment 9

In embodiment 9, the projections of the tabs located on the first surface of the first transfer sheet and the tabs located on the second surface of the first transfer sheet on the first surface do not completely overlap. Referring to FIG. 18, wherein the first cell 31 and the third cell 33 are shown, accordingly, a second cell 32 is provided below the first cell 31, and a fourth cell 34 is provided below the third cell 33. Wherein the first tab 311 protruding from the first cell 31 is the same as described previously, let the position of the first tab 311 protruding from the first cell 31 be P1, and the first tab 311 is welded to the upper surface of the first transfer sheet 41. The third tab 311a protruding from the second cell 32 is different from the third tab in the previous embodiments, therefore labeled differently. It is to be noted that only a part of the third tab 311a is exposed in FIG. 18, and the remainder part of the third tab 311a is welded to the lower surface of the first transfer sheet 41. Assuming the third tab 311a protrudes from the second cell 32 at position P2, and positions P1 and P2 are all staggered. As shown in FIG. 18, the projection areas of the first tab 311 and the third tab 311a on the first surface or the second surface are not overlapping, meaning that they are all staggered and do not overlap at all. In other embodiments, the projection areas of the two may have partial overlap. By analogy for other tabs, such as the second tab 312 and the fourth tab 312a, the fifth tab 331 and the seventh tab 331a, the sixth tab 332 and the eighth tab 332a shown in FIG. 18, will not be expanded here.

The secondary battery shown in embodiment 9 increases the contact area between the tabs and transfer sheet from the whole by setting the projections of the tabs of each cell on the first surface not completely overlap, which is conducive to reducing the internal resistance of the battery, increasing the speed of electron transfer, improving the functional performance of the battery multiplier performance, and speeding up the charging speed.

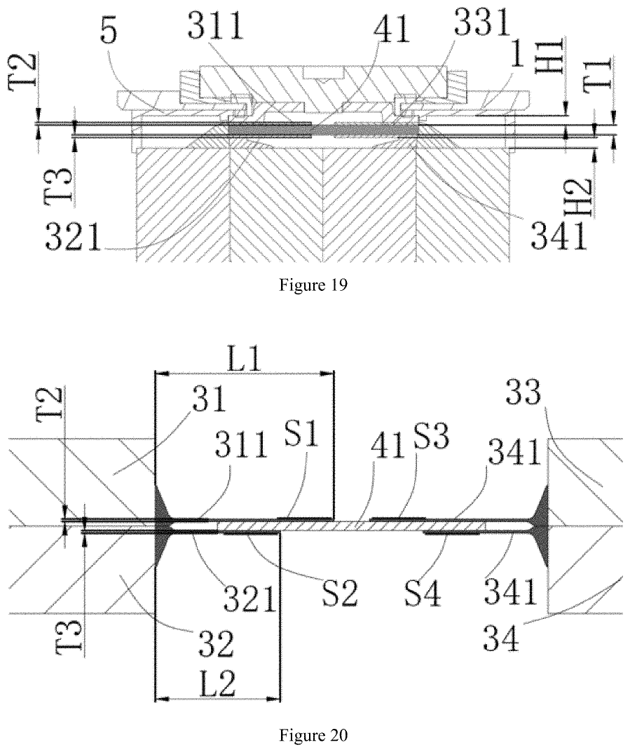

The above listed embodiments 1 to 9 do not exhaust all embodiments of the secondary battery of the present application. In summary, the secondary battery of the above embodiments of the present disclosure has higher volumetric energy density, as shown in FIG. 19 and FIG. 20, the height (gap between the transfer sheet 4 and the bottom of the lower insulating member 5) from the bottom of the lower insulating member 5 to the upper part of the first transfer sheet 41 is H1, the thickness of the first transfer sheet 41 is T1, the total thickness of the multilayer tabs is (T2+T3), the height from the lower part of the tab connection area to the root of the tabs of cell is H2. The sum of these above parameters is the remaining space height of the folded tab, by welding a part of tabs to the first transfer sheet 41, and filling the gap between the first transfer sheet 41 and the bottom of the lower insulating member 5, it reduces the height or thickness occupied by the multilayer tabs, for example, the space height value can be saved by the folded tabs in the present disclosure is the total number of tab layers filled between the first transfer sheet 41 and the bottom of the lower insulating member 5 multiplied by the tab thickness of each layer, increases the volumetric capacity density of the cell. The secondary battery of the present disclosure has the following beneficial effects:

1. The secondary battery of the present disclosure sets the transfer sheet between the upper and lower parts of tabs to connect and fix them, and the upper part of tabs are filled in the gap between the insulating member and the transfer sheet, so as to reduce the space occupied by the folded tabs and improve the volumetric energy density of the cell.

2. The secondary battery of the present disclosure further shortens the path of the first tab and the third tab connected to the transfer sheet, reduces the length of the tab, reduces the dimension of the transfer sheet, improves the effective use of the space inside the secondary battery, which can further improve the energy density of the secondary battery, and reduce the cost of the secondary battery.

3. In the secondary battery of the present disclosure, the first tab and the third tab are kept in the same loose and tight state after being connected and bent to the transfer sheet, so that the loose and tight state of the tabs can be controlled, which not only avoids the broken tab due to tautness which can lead to problems like the decrease of the overcurrent capacity of the tab of cell and short circuit of the cell, but also avoids the problems of the loose tabs being inserted into the inner part of the cell and the contact of the cell sheet causing the short circuit of the cell, and improves the stability and reliability of the tab state in general, and improves the safety of the secondary battery.

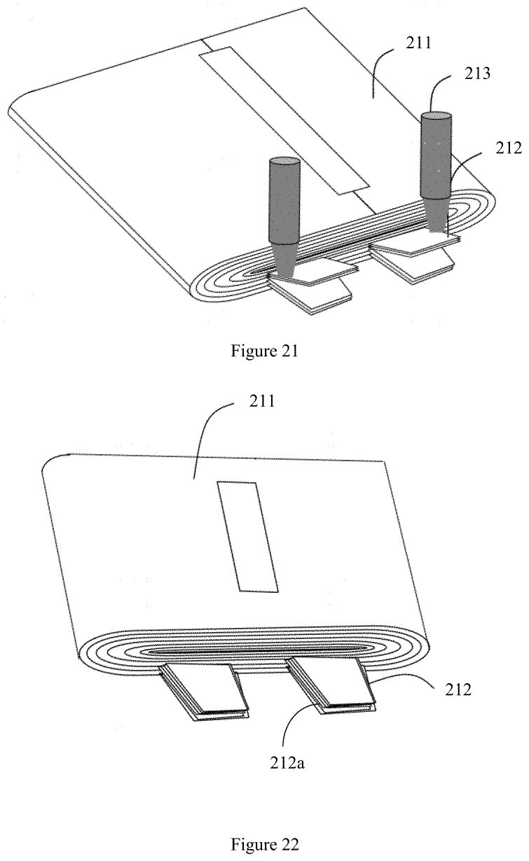

Another aspect of the present disclosure also provides a welding method for a secondary battery, which can solve the problems of the related technology that requires a larger space to accommodate the transfer sheet between the tabs and the top cover, resulting in poor space utilization inside the battery, and the problems of the tabs being set only on one side of the transfer sheet near the cell that can easily cause a short circuit inside the battery. The welding method can be used to weld the secondary battery described previously. As shown in FIG. 21, cells of the secondary battery are winding structure, also referred to as a winding cell. In other embodiments, cells of the secondary battery may also be a laminating structure. As shown in FIG. 21, tabs 212 are led out from the body of the cell 211, and multiple layers of the tabs 212 form a tab set. The cell 211 in this embodiment includes two tab sets protruding from one side of the cell 211, wherein one tab set being the positive tab and the other tab set being the negative tab. In other embodiments, only one tab set may protrude from one side of the cell 211. The welding method of the present disclosure can be used for any one or multiple tab sets in the cell 211.

The present specification uses one cell to illustrate the welding method between tabs and the transfer sheet, the welding method can be used for a secondary battery including multiple cells. For a secondary battery including at least one cell, the welding method of the present disclosure for any tab set of any one of the cells is within the protection scope as claimed in the present disclosure.

Referring to FIG. 21, a welding method for a secondary battery of an embodiment of the present disclosure comprises the following steps:

Step S11: Using suction nozzle 213 to suck at least one tab 212 of a tab set of the cell 211, as shown in FIG. 21, making the tab set being divided into two tab layers along the thickness direction of the cell 211; wherein the cell 211 has at least one tab set, and each tab set includes at least two tabs 212.

Step S12: As shown in FIG. 26, welding the transfer sheet 215 between two layers of the tab layer; specifically, the transfer sheet 215 has a tab connecting part 2151 and a pole connecting part 2152. In this embodiment, the pole connecting part 2152 is located between two cells 211, and the tab connecting part 2151 is welded between two layers of the tab layer.

The present disclosure uses the suction nozzle 213 to divide the tab set into two layers of the tab layer along the thickness direction of the cell 211, making the tab layer near the top cover offset (or partially offset) a part of space occupied by a raised pole connection section 2152 in the thickness direction; and the tab layer near the cell side occupies less space between the cell 211 and the transfer sheet 215 due to the reduced thickness, therefore there is no need to set a large space between the cell and the top cover, thus improving the space utilization inside the battery and increasing the energy density of the battery. On the other hand, in some embodiments, the suction nozzle 213 is a negative pressure nozzle, that is using the negative pressure to suck up tabs and divide them into two layers, which is convenient and efficient to suck up, the suction nozzle 213 can be reused and low-cost, and the suction nozzle 213 is not easy to damage the tab 212, which can reduce the impact on the battery performance and is suitable for mass production.

As shown in FIG. 22, there is a target tab 212a in the middle of the tab set. As a first implementation of the welding method: the suction nozzle 213 is used to suck the target tab 212a in the tab set of the cell 211 (means only use the suction nozzle 213 to suck a tab in the tab set of the cell 1), and the other tabs located on one side of the target tab 212a are lifted at the same time; the dimension of the target tab 212a in the length direction and/or in the width direction is larger than the other tabs in the tab set.

In this implementation, the target tab 212a can be set at any position of the tab set along the thickness direction of the tab 212 according to practical needs, such as making the target tab 212a located in the middle of the tab set, as shown in FIG. 21, when using the suction nozzle 213 to suck the target tab 212a, the other tabs located on one side of the target tab 212a can be lifted together, so that the tab set can be almost evenly divided into two layers. Thus, the number of the tabs 212 on the top and bottom sides of the transfer sheet 215 can be substantially same, and the problem of poor cell consistency caused by the inconsistent number of the tabs 2 on both sides of the transfer sheet 215 is reduced during welding. In the preferred embodiment, there are n overlapping tabs in a tab set, and the target tab 212a is the n/2nd tab counted from the outer side to the inner side, so that when sucking the target tab 212a, the (n/2)−1 tabs located on the side of the target tab 212a are lifted together with the target tab 212a, thereby dividing the tab set equally into two layers with n/2 tabs in each layer. After welding the transfer sheet 215 between two layers of the tab layer, the loose and tight state of the two layers of the tab layer after being connected to the transfer sheet 215 is kept the same, so that the loose and tight state of the two layers of the tab layer can be controlled, which improves the stable reliability of the tab set state, and avoids the problems such as the decreasing of the tab set overcurrent capacity and short circuit of the cell 211 caused by the breakage of the tight tab layer, which also avoids the problems that the loose tab 212 in the tab layer is inserted into the cell 211 and contacts with the cell sheet resulting in a short circuit of the cell 211, and improves the battery safety.

Referring to FIG. 21, further, the suction nozzle 213 can suck both the target tab and at least one tab 212 adjacent thereto.

In some embodiments, the dimension of the target tab in each tab set is typically the largest, and the other tabs adjacent to the target tab are smaller in dimension than the target tab. Dimensions herein include the length and/or width of the tabs. Moreover, the dimension of the other tabs gradually decreases outward from the target tab to form a changing tab with stepped shape, and the suction nozzle 213 can be placed at the step formed by the target tab and one or multiple tabs adjacent thereto and sucking the target tab and the tabs adjacent thereto at the same time, thereby dividing the tab set into two layers, and improving the success rate of dividing the tab set.

As a second implementation of the welding method: at least two tabs 212 on the cell 211 are laminated to form a tab set, one side of the suction nozzle 213 away from the tab 212 can be connected to a negative pressure generator, and the negative pressure value of the negative pressure generator can be set between −10 MPa to −80 MPa; after entering the negative pressure state, the suction nozzle 213 sucks at least one tab 212 of the tab set of the cell 211, thus the tab set is divided into two layers including upper tab layer and lower tab layer, and the transfer sheet 215 can be welded between the two tab layers.

In this implementation, the dimension of each tab 212 of each tab set can be the same (here the dimension refers to the same length and width of the tab), and in step S11, the suction nozzle 213 is used to suck the outermost tab 212 of the tab set, and the number of tabs 212 can be controlled by adjusting the negative pressure value of the negative pressure generator. The suction nozzle 213 can also suck the tabs 212 by aiming at one side of the tabs 212, so that the tabs 212 are layered at the desired position. For example, sucking the target tab on one side of the tabs 212, and moving the suction nozzle 213 so that the target tab and the other tabs on its side are lifted together.

With this embodiment, each tab 212 of each tab set has the same dimension, which reduces the production cost of the cell compared to the first embodiment.

The present disclosure does not limit the principle of using the suction nozzle 213 to suck the tabs 212. Any technology that can suck the tabs 212 and thus facilitate the lifting of the tabs 212 is within the protection scope of the present disclosure. For example, the negative pressure generator described above can be specifically implemented as a vacuum generator. A further example would be to connect the suction nozzle 213 to a manual pumping device, a negative pressure and suction would be generated at the suction nozzle 213 by manual pumping.

As a third embodiment of the present welding method, on the basis of the first embodiment or the second embodiment:

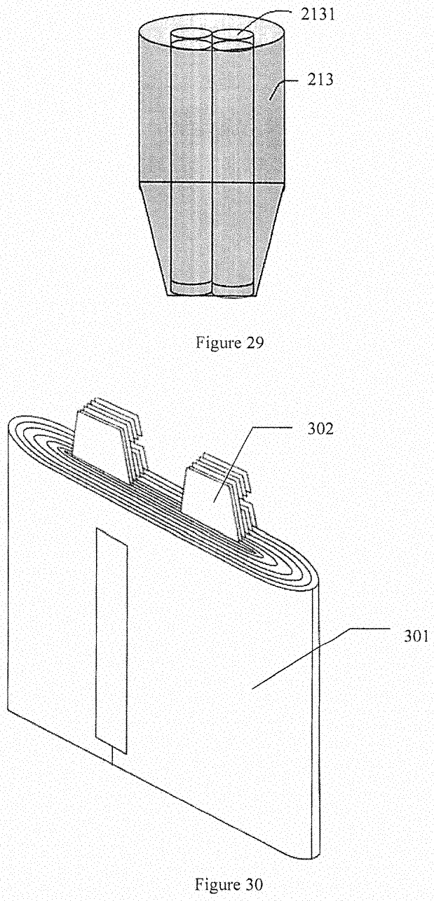

In some embodiments, referring to FIG. 29, the suction nozzle 213 may have at least two channels 2131, and by providing at least two channels 2131 on the suction nozzle 213, when the suction nozzle 213 is sucking the tab 212 in the tab set, the two channels 2131 act simultaneously, further improving the success rate of layering the tab set and reducing the number of reworking.

Wherein, two or multiple channels 2131 can be provided side by side on one suction nozzle 213 or be provided separately on multiple suction nozzles 213. An embodiment with four channels 2131 in one suction nozzle 213 is illustrated in FIG. 29.

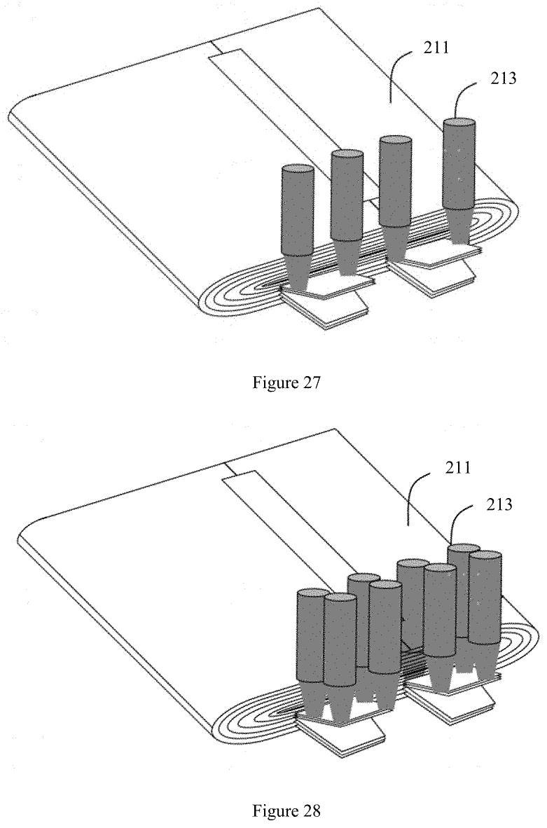

In some embodiments, referring to FIG. 27, at least two suction nozzles 213 are used to suck each side of the tab 212 respectively. As shown in FIG. 27, the tab 212 has two opposite sides along the width direction of the cell 211, and at step S11, setting one suction nozzle 213 at one side of the tab 212, and the other suction nozzle 213 is set at the other side of the tab 212, the two suction nozzles 213 work simultaneously to suck at least one tab 212.

In this embodiment, by setting at least two suction nozzles 213 and suctioning both sides of the tab 212 respectively, and at least two suction nozzles 213 sucking at the same time, it further improves the success rate of layering the tab set and reduces the number of reworking.

Referring to FIG. 28, when using four suction nozzles 213, four suction nozzles 213 can be placed on each of the four corners of the tab 212. In other embodiments other number of the suction nozzles 213 can be used, and the position of the suction nozzles 213 can be analogous to this embodiment.

In some embodiments, referring to FIG. 21, further, after using the suction nozzle 213 to suck at least one tab 212 of the tab set of the cell 211 in step S11, it may also include: monitoring the negative pressure value of the negative pressure generator, and determining whether the tab 212 is successfully sucked based on the negative pressure value; if the negative pressure value is stable (in the present disclosure, the negative pressure value is stable means, during the process from the suction nozzle 213 starts sucking the tab 212 to the end of sucking (that is removing the negative pressure of the negative pressure generator), the range of the negative pressure value of the negative pressure generator is within 0.005 MPa), then the tab 212 is sucked successfully, and if the negative pressure value is not stable, then the tab 212 is not sucked successfully.

In this embodiment, by monitoring the negative pressure value of the negative pressure generator, if the tab 212 falls during the suction process of the suction nozzle 213, and the suction nozzle 213 inhales air, the negative pressure value will be unstable. If the suction nozzle 213 successfully sucks up the tab 212 and makes the tab set layered, the suction nozzle 213 will remain in a stable state, so that it can be judged whether the tab 212 is successfully sucked up or not, and if it is not successfully sucked up then it needs to be sucked up again, thus to avoid subsequent welding of the transfer sheet 215 on the unlayered tab set, resulting in unstable product quality.

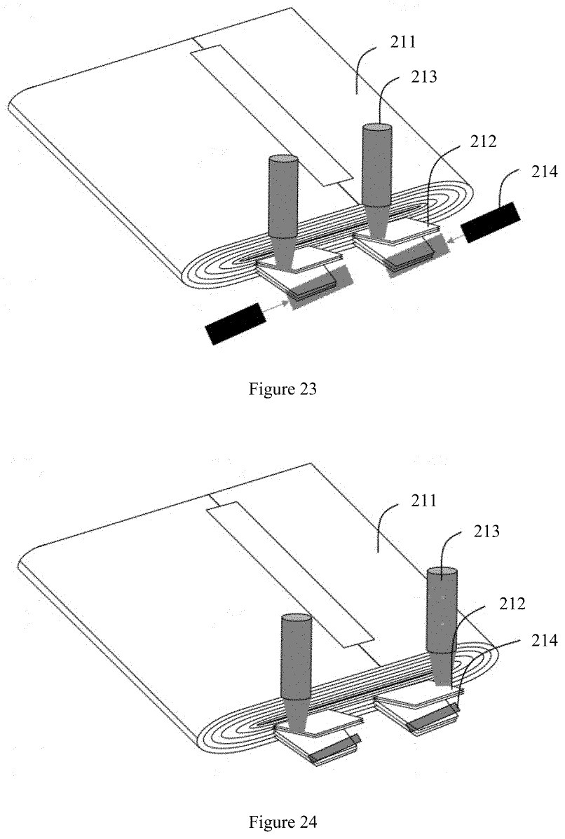

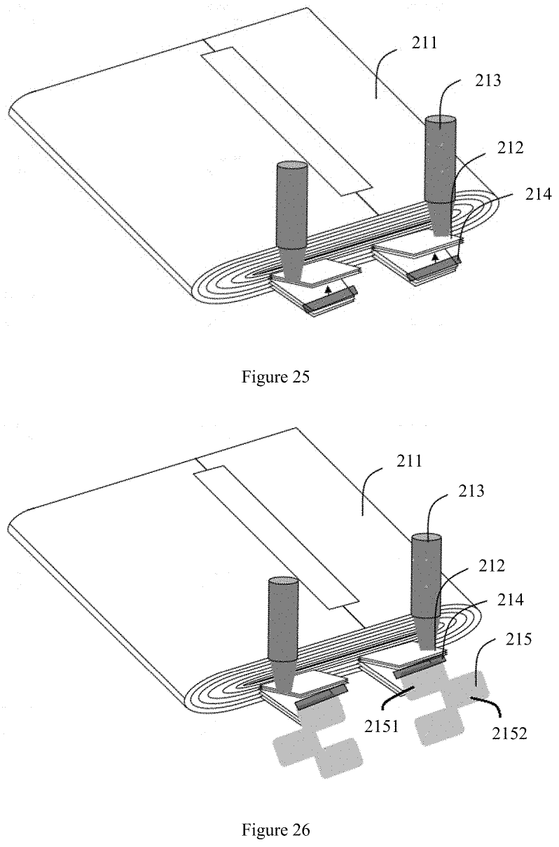

In some embodiments, referring to FIG. 23 to FIG. 25, further, after using the suction nozzles 213 to suck at least one tab 212 of the tab set of the cell 211, it can also include: placing the insertion rod 214 between two layers of the tab layer, and removing the negative pressure of the negative pressure generator; lifting the insertion rod 214, making the tab set being divided into two layers of the tab layer along the thickness direction of the cell 211.

In this embodiment, by using the insertion rod 214 to enter between two layers of the tab layer and raise the upper tab layer, the tab set is hold in a layered state, and waiting for the transfer sheet 215 to enter between two layers of the tab layer for welding. It can also increase the space between two layers of the tab layer, thus facilitate the transfer sheet 215 to enter between two layers of the tab layer from lower side of the insertion rod 214, as shown in FIG. 26.

In some embodiments, referring to FIG. 23, the insertion rod 214 is mounted on a first servo mechanism (not shown in figures), and using the first servo mechanism to drive the insertion rod 214 to move between two layers of the tab layer. In this embodiment, the servo mechanism can drive the tab 212 to achieve three-axis movement, so that the insertion rod 214 can automatically enter between two layers of the tab layer and raise the upper tab layer, which is convenient, fast, time saving and labor saving.

In some embodiments, before welding the transfer sheet 215 between two layers of the tab layer, it can also include: using a second servo mechanism to drive the transfer sheet 215 into the space between the two layers of the tab layer in a direction parallel to the plane of the tab 212 (the plane of the tab 212 in the present disclosure refers to the plane formed by the length and width of the tab). In this embodiment, the loading method of the transfer sheet 215 is changed from original cylinder loading to the second servo mechanism loading, and from original vertical loading to horizontal loading, that is making the transfer sheet 215 enters between two layers of the tab layer in the direction parallel to the plane of the tab 212, so that the transfer sheet 215 can be placed between two layers of the tab layer without separating the tab layers too far, which reduces the difficulty of layering the tab set, and improves the efficiency.

Referring to FIG. 21-FIG. 28, the specific steps of a welding method of a secondary battery provided by an embodiment of the present disclosure include:

Tab set layering: before ultrasonic welding the cell 211, the tab set is divided into two layers of the tab layer by using the suction nozzles 213 to suck up the tab 212 and making the insertion rod 214 enter between two layers of the tab layer and lifts, and increasing the spacing between two layers of the tab layer.

Transfer sheet 215 entry: removing the negative pressure, loading the transfer sheet 215 between two layers of the tab layer, and removing the insertion rod 214.

Ultrasonic welding: ultrasonically welding the transfer sheet 215 and the both sides of the tab layer.

On the other hand, the present disclosure also includes a secondary battery made according to the welding method described above, the secondary battery comprising: at least two cells 211 and a transfer sheet 215, wherein the cells 211 have at least one tab set protruding outward from it; referring to FIG. 26, the transfer sheet 215 has a tab connecting part 2151, the tab connecting part 2151 being used to separately weld to one tab set in each cell 211, and the tab connecting part 2151 is located between two layers of the tab layer of the tab set.

The welding method of a secondary battery of the present disclosure uses the suction nozzle to suck the tabs so that the tab set is divided into two layers, and the tab layer near the top cover side can offset a part of space occupied by the raised pole connecting part in the thickness direction, and this part of the tab layer can be filled in the gap between the plastic and the transfer sheet, thus reducing the space occupied by the folded tab, and the space occupied between the cell to the transfer sheet is also reduced due to the thickness reducing of the tab layer near the side of the cell, means there is no need to set a large holding space between the tab and the top cover, which improves the effective use of space inside the battery, reduces the space occupied by the folded tab, improves the energy density of the battery and reduces the cost of the battery. In addition, by setting the tab connecting part 2151 of the transfer sheet 5 between the upper and lower two layers of the tab layer for welding and fixing, the welding method also shortens the path for connecting the tab set to the transfer sheet 215 and reduces the length of the tab set. Herein the plastic refers to the lower insulating member 5 shown previously and in FIG. 19.

In combination with the secondary battery described previously, and reference to FIG. 6, the secondary battery also includes a top cover 1 and a pole 2, the pole 2 includes a first pole provided in the top cover 1, the cell 3 includes a first cell 31, the first cell 31 leading out a first tab set and a second tab set, the first tab set includes a first tab 311, the second tab set includes a second tab 312, the first tab 311 and the second tab 312 have opposite polarity. The transfer sheet 4 includes a first transfer sheet 41, and the first transfer sheet 41 electrically connects the first tab 311 to the first pole; wherein the first transfer sheet 41 has a first surface and a second surface oppositely, the step S11 of welding the transfer sheet 4 between two layers of the tab layer further includes: connecting a part of tabs of the first tab 311 to the first surface, and connecting the other part of the tabs of the first tab 311 to the second surface, so that the first transfer sheet 41 is located between a part of tabs of the first tab 311 and the other part of the tabs of the first tab 311.

Referring to FIG. 6, in some embodiments, the cell 3 also includes a second cell 32, the second cell 32 leading out a third tab 321 and a fourth tab 322 with opposite polarity; the third tab 321 and the first tab 311 are located on the same side of the first transfer sheet 41; the step S11 of welding the transfer sheet 4 between two layers of the tab layer also includes: connecting the other part of tabs of the first tab 311 and all tabs of the third tab 321 to the second surface, so that the first transfer sheet 41 is located between a part of tabs of the first tab 311 and the other part of tabs of the first tab 311 and the third tab 321.

Referring to FIG. 1 and FIG. 21, in some embodiments, the cell 3 of the secondary battery of the present disclosure includes a first cell 31 and a second cell 32, the first cell 31 and the second cell 32 are adjacent in the thickness direction, and the tab set of the first cell 31 and the tab set of the second cell 32 are adjacent in the thickness direction and form a combined tab set; the welding method includes the following steps:

Step S21: Using suction nozzles 213 to suck at least one tab of the combined tab set, so that the combined tab set is divided into two layers of the tab layer along the thickness direction; and

Step S22: Welding the transfer sheet 4 between the two layers of the tab layer in the combined tab set.

In these embodiments, there is no restriction on whether the tab drawn by the suction nozzles 213 belongs to the first cell 31 or the second cell 32, means there is no restriction on the location of the target tab. In some embodiments, the tab drawn by the suction nozzles 213 is a part of tabs in the first cell 31 or a part of tabs in the second cell 32. In some embodiments, the tabs drawn by the suction nozzles 213 are all tabs of the first cell 31 or all tabs of the second cell 32.

Specifically, referring to FIG. 1, FIG. 2, FIG. 5, and FIG. 6, the first cell 31 leading out a first tab set and a second tab set, the first tab set includes a first tab 311, and the second tab set includes a second tab 312, the first tab 311 and the second tab 312 having opposite polarity; the transfer sheet 4 includes a first transfer sheet 41, the first transfer sheet 41 electrically connected the first tab 311 to the first pole; wherein the first transfer sheet 41 has a first surface and a second surface oppositely, and the step of welding the transfer sheet 4 between two layers of the tab layer in the combined tab set further comprises: connecting a part of tabs of the first tab 311 to the first surface, and the other part of tabs of the first tab 311 to the second surface, such that the first transfer sheet 41 is located between a part of tabs of the first tab and the other part of tabs of the first tab, as shown in FIG. 6, or, connecting all tabs of the first tab 311 to the first surface, as shown in FIG. 5.

In some embodiments, referring to FIG. 1, FIG. 2, FIG. 4, FIG. 6 and FIG. 7, the cell 3 further comprises a third cell 33, the third cell 33 leading out a fifth tab 331 and a sixth tab 332 with opposite polarity; the step of welding the transfer sheet 4 between two layers of the tab layer in the combined tab set further comprises: connecting a part of tabs of the fifth tab 331 to the first surface, and connecting the other part of tabs of the fifth tab 331 to the second surface, referring to FIG. 6, wherein the first tab 311 is located on one side of the first transfer sheet 41, and the fifth tab 331 is located on the opposite side of the first transfer sheet 41; or, the cell 3 further comprises a third cell 33 and a fourth cell 34, the third cell 33 leading out a fifth tab 331 and a sixth tab 332 with opposite polarity, the fourth cell 34 leading out a seventh tab 341 and an eighth tab 34 with opposite polarity; the step of welding the transfer sheet 4 between two layers of the tab layer in the combined tab set also includes: connecting all tabs of the fifth tab 331 to the first surface, and connecting all tabs of the seventh tab 341 to the second surface, as shown in FIG. 4, or, connecting a part of tabs of the fifth tab 331 to the first surface, connecting the other part of tabs of the fifth tab 331 and all tabs of the seventh tab 341 to the second surface, as shown in FIG. 6, or, connecting all tabs of the fifth tab 331 and a part of tabs of the seventh tab 341 to the first surface, and connecting the other part of tabs of the seventh tab 341 to the second surface, as shown in FIG. 7, wherein the first tab 311 is located on one side of the first transfer sheet 41, the fifth tab 331 and the seventh tab 341 are located on opposite sides of the first transfer sheet 41.

As shown in FIG. 30 to FIG. 33, the present disclosure also provides a cell, comprising a cell body 301 and at least two tabs 302 (at least one of which is a positive tab, and at least one of which is a negative tab), wherein the cell body 301 is equivalent to the body of the cell described previously. The tabs 302 are all disposed at one end or one side of the cell body 301 as described above, such that after winding, the tabs 302 are protruding from the same side of the cell body 301. Each tab 302 includes a first conductive sheet set and a second conductive sheet set which are setting in sequence along the thickness direction of the cell body 301, and the first conductive sheet set includes a first conductive sheet 3021; the second conductive sheet set includes a second conductive sheet 3022; in the same tab 302, the first conductive sheet 3021 and the second conductive sheet 3022 have the same or different numbers, and the second conductive sheet set has an assembly section. The assembly section is used to allow ejector pin 303 to pass through and withstand the first conductive sheet set, thus facilitating the separation of the first conductive sheet set and the second conductive sheet set and facilitating welding the transfer sheet 304 between the first conductive sheet set and the second conductive sheet set after the subsequent welding process.

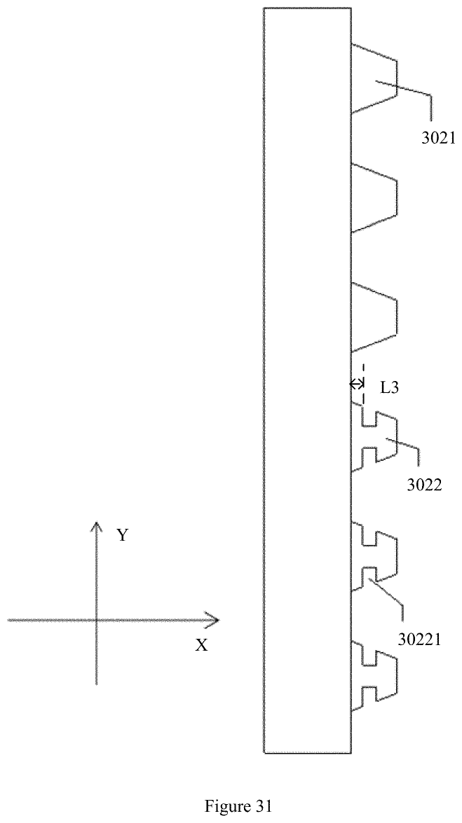

FIG. 31 shows a diagram of a positive/negative sheet before winding the cell, as shown in FIG. 31, the first conductive sheet 3021 and the second conductive sheet 3022 on the positive/negative sheet are set on the same side of the positive/negative sheet body along the width direction (width direction is X direction in FIG. 31), and the first conductive sheet 3021 and the second conductive sheet 3022 are set sequentially at intervals in the length direction of the positive/negative sheet body (the length direction is the Y direction in FIG. 31).

When the positive sheet, the negative sheet and the diaphragm are winding to form a cell body 301, the first conductive sheet 3021 and the second conductive sheet 3022 on the positive/negative sheet are laminated in the thickness direction of the cell body 301, and forming at least one tab 302, each tab 302 includes a first conductive sheet set and a second conductive sheet set which are setting in sequence along the thickness direction of the cell body 301.

In other embodiments, the first conductive sheet 3021 and the second conductive sheet 3022 may be directly connected to the cell body 301, and there is no specific limitation of the connection method between the first conductive sheet 3021 and the second conductive sheet 3022 and the cell body 301.

Further, the assembly section may be a notch or a through-hole. The notch refers to having an opening on the edge of the second conductive sheet 3022, and the through-hole is a through-hole located inside the second conductive sheet 3022. The present disclosure does not limit the shape of the through-hole, which may be a square hole, a round hole, an irregularly-shaped hole, and so on.

Referring to FIG. 31, in some embodiments, notches 30221 or through-holes are provided in each of the second conductive sheets 3022. Specifically, notches 30221 may be provided on each of the second conductive sheets 3022 within the second conductive sheet set; or through-holes may be provided on each of the second conductive sheets 3022 within the second conductive sheet set; or through-holes may be provided on a part of the second conductive sheets 3022 within the second conductive sheet set, and notches 30221 may be provided on the other part. The present disclosure does not limit the dimension and location of the notches 30221 or through-holes, as long as they can be passed through by the ejector pin 303.

In the preferred embodiment, notches 30221 are provided on each second conductive sheet 3022. Compared with through-holes, the assembly section formed by the notches 30221 makes it easier for the ejector pin 303 to pass through the second conductive sheet set.

Preferably, as shown in FIG. 31, two notches 30221 are provided on each of the above mentioned second conductive sheets 3022, which respectively located on both sides of each second conductive sheet 3022 in the Y direction. According to these embodiments, the ejector pin 303 can jack up the first conductive sheet set from both sides of the first conductive sheet set, and the jacking process is more stable.

In other embodiments, the number of notches 30221 opened on each second conductive sheet 3022 may not be limited, for example, the number of notches 30221 opened on each second conductive sheet 3022 may also be one, three or four, and so on, but it should be noted that due to the notches 30221 are opened on each second conductive sheet 3022, it is necessary to consider the minimum destructive factors of opening the notches 30221 to the structure of the second conductive sheet set, so as to avoid causing malfunction when welding the second conductive sheet set with the transfer sheet 304 or when using them.

It should be noted that the first conductive sheet 3021 and the second conductive sheet 3022 are preferably of the same shape and dimension, and the first conductive sheet set should completely cover the through-holes or notches 30221 on each second conductive sheet 3022, which to avoid that the ejector pin 303 cannot be held against the first conductive sheet 3021 after passing through the second conductive sheet 3022.

In some optional embodiments, the above first conductive sheet 3021 and the above second conductive sheet 3022 are both trapezoids of the same shape.

In some optional embodiments, the above mentioned each first conductive sheet 3021 and the above mentioned each second conductive sheet 3022 are isosceles trapezoid, then two of the above mentioned notches 30221 on each second conductive sheet 3022 are provided symmetrically with respect to the plane in which the axis of symmetry of each second conductive sheet 3022 is located (the plane here is the plane perpendicular to the XY plane in FIG. 31). The purpose of such setting is that it can ensure the jacking force of two ejector pins 303 is balanced when the two ejector pins 303 pass through the two notches 30221 on each second conductive sheet 3022 respectively and is held against the first conductive sheet set, so that the first conductive sheet set is stably lifted.

In other embodiments, the shape of the first conductive sheet 3021 and the second conductive sheet 3022 may not be limited and can be set according to the design requirements.

Further, the notch 30221 on each of the above mentioned second conductive sheet 3022 can be configured as a rectangle tangent to the outer diameter of the above mentioned ejector pin 303.

Due to the notch 30221 on each second conductive sheet 3022 needs to be considered for minimal damage to the structure of the second conductive sheet 3022, the notch 30221 on each second conductive sheet 3022 is opened on both sides of the second conductive sheet 3022 in the Y direction and being a rectangle that fits the diameter of the ejector pin 303, which to form a U shaped avoidance slot for the ejector pin 303 to pass through. The advantage of such a setting is that the ejector pin 303 can pass through and lift up the first conductive sheet set based on minimal disruption of the structure of the second conductive sheet 3022, and the two notches 30221 on each second conductive sheet 3022 can be spaced apart enough to avoid the welding points of the transfer sheet 304.

As shown in FIG. 31, in some optional embodiments, the notches 30221 on each of the above mentioned second conductive sheets 3022 are set a setting distance L3 from the above mentioned cell body 301.

When opening notches 30221, the avoidance of the welding points is not the only consideration. Since the opening of notch 30221 will produce burrs which may cause damage to the cell body, and even cause positive and negative short circuits, the notch 30221 should be kept away from the cell body 301 at the same time. Therefore, in this embodiment, the notch 30221 is provided at a setting distance L3 from the cell body, and the value of the setting distance L3 is provided according to the dimension of the second conductive sheet 3022.

Preferably, L3 is at least 6 mm, and it enables the notch 30221 to have no effect on the cell body 301 by setting L3 within this range. It should be noted that, the range may apply to L3 when the second conductive sheet 3022 has a dimension of at least 14 mm in the X direction.

In some optional embodiments, the number of first conductive sheets 3021 included within the same first conductive sheet set is the same as the number of second conductive sheets 3022 included in the second conductive sheet set or the difference in number is one sheet.

The advantage of this setting is that, when the ejector pin 303 passes through the second conductive sheet set and holds against the first conductive sheet set, it can quickly divide the tab 302 into two parts of approximately the same thickness, so that the number of the first conductive sheets 3021 and the number of the second conductive sheets 3022 respectively located on the upper and lower sides of the transfer sheet 304 are substantially the same, which can further reduce the problem of redundancy of the tab 302, and the space between the tab and the top cover is further reduced at the same time.

Preferably, the above battery has two tabs 302 (one tab is positive tab and one tab is negative tab), each of the above tabs 302 includes three first conductive sheets 3021 and three second conductive sheets 3022.

In other embodiments, the specific number of the first conductive sheets 3021 and the second conductive sheets 3022 in the tabs 302 can be provided according to the design requirements of the cell and will not be limited here.

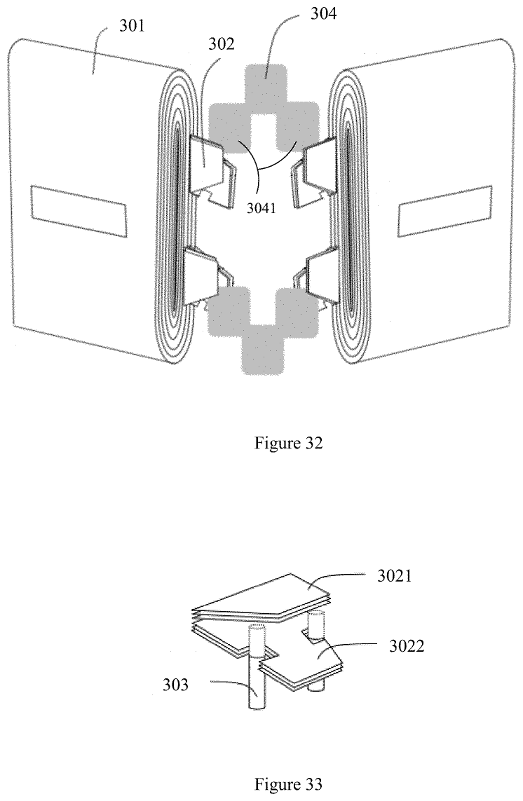

As shown in FIG. 32, the present disclosure also provides a secondary battery, comprising at least two of the above mentioned cells 301 and at least one transfer sheet 304.

The transfer sheet 304 has a tab connecting part 3041, the tab connecting part 3041 is respectively welded to the corresponding tab 302 on the cell, and the tab connecting part 3041 is welded between the first conductive sheet set and the second conductive sheet set in the tab 302.

In the present disclosure, two tabs 302 protrude outward from one side of the cell body 301 of each cell, which respectively to be used as the positive electrode and the negative electrode of the secondary battery, the transfer sheet 304 is provided with two, one transfer sheet 304 connecting the positive tabs of the two cells, and the other connecting the negative tabs of the two cells.

During welding, the tab connecting part 3041 of the transfer sheet 304 needs to be welded between the first conductive sheet set and the second conductive sheet set, which dividing the tab 302 into two layers of the same thickness in the thickness direction.

The present disclosure also provides a welding method for a secondary battery, utilizing the cells shown in FIG. 30 to FIG. 33, comprising the following steps:

Step S31: As shown in FIG. 33, passing the ejector pin 303 through the assembly section of the second conductive sheet set of all the above mentioned tabs 302 and holding it against the first conductive sheet set of the same tabs 302, so as to separate the above mentioned first conductive sheet set and the second conductive sheet set.

Step S32: As shown in FIG. 32, placing the tab connecting part 304 of the transfer sheet 304 between the above mentioned first conductive sheet set and second conductive sheet set.

Here it should be noted that, the transfer sheet 304 should avoid the position of through-hole or notch 30221 to prevent unstable welding.

Step S33: Withdrawing the ejector pin 303 and welding the tab connecting part 3041 of the transfer sheet 304 between the first conductive sheet set and the second conductive sheet set.

It should be noted that, the top of the ejector pin 303 should be avoided to be too sharp, so as to prevent damage to the first conductive sheet set, preferably, the ejector pin 303 is cylindrical. And the through-holes or notches 30221 on each second conductive sheet 3022 should be opened in such a way as to avoid interfering with the welding of the transfer sheet 304.

When the tab connecting part 3041 of the transfer sheet 304 is placed between the first conductive sheet set and the second conductive sheet set, the ejector pin 303 can be withdrawn, so that the tab connecting part of the transfer sheet 304 is sandwiched between the first conductive sheet set and the second conductive sheet set. In the embodiment of the present disclosure, the number of the first conductive sheets 3021 in the first conductive sheet set and the number of the second conductive sheets 3022 in the second conductive sheet set are the same or differ by one sheet, at this time, the number of the first conductive sheets 3021 and the number of the second conductive sheets 3022 on the upper and lower sides of the tab connecting part 304 of the transfer sheet 304 is basically the same. At this time, the tab connecting part 304 of the transfer sheet 304 and the first conductive sheet set and the second conductive sheet set can be welded, so as to achieve the centering welding of the transfer sheet 304 on the tab.

Referring to FIG. 21, FIG. 30 and FIG. 31, the welding method of the present disclosure further includes the following steps:

Step S41: Inserting the suction nozzle 213 into the notch 30221 or through-hole on the second conductive sheet 3022.

Step S42: Applying negative pressure to make the suction nozzle 213 to suck the target conductive sheet adjacent to the second conductive sheet 3022 in the first conductive sheet set, and the target conductive sheet drives all first conductive sheets to lift together, so that the tab 302 is divided into two layers. One layer includes the target conductive sheet and all first conductive sheets, and the other layer is the remaining conductive sheets in the first conductive sheet set except for the target conductive sheet.

According to the welding method of this embodiment, it is necessary to set the shape and dimension of the suction nozzle 213 to match the shape and dimension of the notch 30221 or the through-hole, so that the suction nozzle 213 can pass through the notch 30221 or the through-hole, and come into contact with the target conductive sheet. The target conductive sheet is equivalent to the target tab as described previously, and by setting the position of the target conductive sheet, the tab 302 can be divided equally into two equal layers.

Using the welding method as described above, the first conductive sheet set near the top cover side in the thickness direction can offset a part of space which is occupied by the raised pole connection section, in addition, the first conductive sheet set near the top cover side can fill in the gap between the plastic and the transfer sheet, thus reducing the space occupied by the folded tab; and the space occupied by the second conductive sheet set near the cell side between the cell and the transfer sheet is also reduced due to the thickness reduction, means there is no need to set a larger space between the tab and the top cover. In this way, the effective utilization space inside the secondary battery is improved, the energy density of the secondary battery is increased, and the cost of the secondary battery is reduced. Next, it can reduce the redundancy problem of the tab, and reduce the problem of short circuit inside the battery. Finally, the tab is divided into two layers and welded to the transfer sheet, which is more conducive to the stability of welding.

In the description of the present disclosure, it is to be understood that the terms “top”, “bottom”, “front”, “back”, “left”, “right”, “vertical”, “horizontal”, “top”, “bottom”, “inside”, “outside”, and so on which indicate the orientation or position relationship based on the orientation or position relationship shown in figures, it is only intended to facilitate and simplify the description of the present disclosure, and not to indicate or imply that the devices or elements referred to must have a particular orientation, be constructed and operate in a particular orientation, therefore cannot be construed as a limitation of the present disclosure.

Specific embodiments of the present disclosure have been described above. It is needed to be understood, that the present disclosure is not limited to the specific embodiments described above, and that a person skilled in the art may make various variations or modifications within the scope of the claims, which do not affect the substance of the present disclosure. Without conflict condition, the features in embodiments and implementations of the present application can be combined with each other at will.

What is claimed is:

1. A secondary battery, wherein comprising a top cover, a pole, a cell and a transfer sheet, wherein
the pole comprising a first pole, which being provided in the top cover;
the cell comprising a first cell, the first cell leading out a first tab and a second tab with opposite polarity;
the transfer sheet comprising a first transfer sheet, the first transfer sheet electrically connecting the first tab to the first pole;
wherein the first transfer sheet having a first surface and a second surface oppositely, the first tab and the first transfer sheet being connected in any of the following two ways: a part of tabs of the first tab being connected to the first surface, other part of tabs of the first tab being connected to the second surface, the first transfer sheet being located between the part of tabs of the first tab and the other part of tabs of the first tab, or, all tabs of the first tab being connected to the first surface of the first transfer sheet.

2. The secondary battery according to claim 1, wherein the cell further comprising a second cell, the second cell leading out a third tab and a fourth tab with opposite polarity; the third tab and the first tab being located on the same side of the first transfer sheet.

3. The secondary battery according to claim 2, wherein when all tabs of the first tab being connected to the first surface of the first transfer sheet, and all tabs of the third tab being connected to the second surface of the first transfer sheet, the first transfer sheet being located between the first tab and the third tab.

4. The secondary battery according to claim 2, wherein when a part of tabs of the first tab being connected to the first surface of the first transfer sheet, other part of tabs of the first tab and all tabs of the third tab being connected to the second surface of the first transfer sheet, the first transfer sheet being located between a part of tabs of the first tab and other part of tabs of the first tab and the third tab.

5. The secondary battery according to claim 2, wherein when all tabs of the first tab being connected to the first surface of the first transfer sheet, all tabs of the first tab and a part of tabs of the third tab being connected to the first surface of the first transfer sheet, and other part of tabs of the third tab being connected to the second surface of the first transfer sheet, the first transfer sheet being located between the first tab and a part of tabs of the third tab and other part of tabs of the third tab.

6. The secondary battery according to claim 2, wherein the first tab being led out from the outer side of the first cell, and the third tab being led out from the outer side of the second cell.

7. The secondary battery according to claim 1, wherein tab and the first transfer sheet forming a first connection area on the first surface, tab and the first transfer sheet forming a second connection area on the second surface, the first connection area and the second connection area being opposite or at least partially staggered.

8. The secondary battery according to claim 1, wherein tab located on the first surface of the first transfer sheet and tab located on the second surface of the first transfer sheet having equal or unequal lengths, and the tab located on the first surface of the first transfer sheet and the tab located on the second surface of the first transfer sheet having the same or different number of layers.

9. The secondary battery according to claim 1, wherein the projections on the first surface of tab located on the first surface of the first transfer sheet and tab located on the second surface of the first transfer sheet do not completely overlap.

10. The secondary battery according to claim 1, wherein the cell further comprising a third cell, the third cell leading out a fifth tab and a sixth tab with opposite polarity; the first tab being located on one side of the first transfer sheet, the fifth tab being located on the opposite side of the first transfer sheet, a part of tabs of the fifth tab being connected to the first surface, and other part of tabs of the fifth tab being connected to the second surface;
or, the cell further comprising a third cell and a fourth cell, the third cell leading out a fifth tab and a sixth tab with opposite polarity, and the fourth cell leading out a seventh tab and an eighth tab with opposite polarity; the first tab being located on one side of the first transfer sheet, the fifth tab and the seventh tab being located on opposite side of the first transfer sheet; wherein all tabs of the fifth tab being connected to the first surface of the first transfer sheet, and all tabs of the seventh tab being connected to the second surface of the first transfer sheet, or, a part of tabs of the fifth tab being connected to the first surface of the first transfer sheet, other part of tabs of the fifth tab and all tabs of the seventh tab being connected to the second surface of the first transfer sheet, or, all tabs of the fifth tab and a part of tabs of the seventh tab being connected to the first surface of the first transfer sheet, other part of tabs of the seventh tab being connected to the second surface of the first transfer sheet.

11. A welding method for a secondary battery, the secondary battery comprising a cell and a transfer sheet, wherein comprising following steps:
sucking at least one tab of a tab set of the cell using a suction nozzle so that the tab set being divided into two tab layers along the thickness direction of the cell, wherein the cell having at least one tab set, and each tab set including at least two tabs; and
welding the transfer sheet between two layers of the tab layer.

12. The welding method according to claim 11, wherein using the suction nozzle to suck up a target tab in the tab set and causing other tab located on the side of the target tab to be lifted at the same time, wherein the target tab having a dimension in the length direction and/or a dimension in the width direction which greater than the other tab of the tab set.

13. The welding method according to claim 12, wherein the suction nozzle simultaneously sucking the target tab and at least one of the tabs adjacent to the target tab.

14. The welding method according to claim 13, wherein the dimension of other tabs adjacent to the target tab decreasing gradually outward from the target tab and forming a changing tab with stepped shape.

15. The welding method according to claim 11, wherein the suction nozzle having at least two, and the at least two suction nozzles sucking on each side of the tab separately.

16. The welding method according to claim 11, wherein an end of the suction nozzle away from the tab being connected to a negative pressure generator, after the step of sucking at least one tab of a tab set of the cell using a suction nozzle, further comprising:
monitoring a negative pressure value of the negative pressure generator, determining whether the tab being successfully sucked according to the negative pressure value; if the negative pressure value being stable, then the tab being successfully sucked, if the negative pressure value being unstable, then the tab being not successfully sucked.

17. The welding method according to claim 16, wherein after the step of sucking at least one tab of a tab set of the cell using a suction nozzle, further comprising:
placing an insertion rod between two layers of the tab layer, and removing negative pressure from the negative pressure generator; and
lifting the insertion rod so that the tab set being divided into two tab layers along the thickness direction of the cell.

18. The welding method according to claim 17, wherein the insertion rod being installed on a first servo mechanism, using the first servo mechanism to drive the insertion rod to move between two layers of the tab layer.

19. The welding method according to claim 11, wherein prior to the step of welding the transfer sheet between two layers of the tab layer, further comprising: driving the transfer sheet in a direction parallel to the plane of the tab to enter between two layers of the tab layer using a second servo mechanism.

20. The welding method according to claim 11, wherein the secondary battery further comprising a top cover and a pole, wherein
the pole comprising a first pole, which being provided in the top cover;
the cell comprising a first cell, the first cell leading out a first tab set and a second tab set, the first tab set comprising a first tab and the second tab set comprising a second tab, the first tab and the second tab having opposite polarity;
the transfer sheet comprising a first transfer sheet, the first transfer sheet electrically connecting the first tab to the first pole;
wherein the first transfer sheet having a first surface and a second surface oppositely, the step of welding the transfer sheet between two layers of the tab layer further comprising: connecting a part of tabs of the first tab to the first surface, and connecting other part of tabs of the first tab to the second surface, such that the first transfer sheet being located between a part of tabs of the first tab and the other part of tabs of the first tab.

21. The welding method according to claim 20, wherein the cell further comprising a second cell, the second cell leading out a third tab and a fourth tab with opposite polarity; the third tab and the first tab being located on the same side of the first transfer sheet; the step of welding the transfer sheet between two layers of the tab layer further comprising: connecting the other part of tabs of the first tab and all tabs of the third tab to the second surface, such that the first transfer sheet being located between a part of tabs of the first tab and the other part of tabs of the first tab and the third tab.

22. A welding method for a secondary battery, wherein the secondary battery comprising a cell, a transfer sheet, a top cover and a pole, wherein
the pole comprising a first pole, which being provided in the top cover;
the cell comprising a first cell and a second cell, the first cell and the second cell being adjacent in the thickness direction of the secondary battery, tab set of the first cell and tab set of the second cell being adjacent in the thickness direction and forming a combined tab set;
the welding method comprising steps: sucking at least one tab of the combined tab set using a suction nozzle, such that the combined tab set being divided into two layers of the tab layer along the thickness direction; and
welding the transfer sheet between two layers of the tab layer in the combined tab set.

23. The welding method according to claim 22, wherein the first cell leading out a first tab set and a second tab set, the first tab set comprising a first tab and the second tab set comprising a second tab, the first tab and the second tab having opposite polarity; the transfer sheet comprising a first transfer sheet, the first transfer sheet electrically connecting the first tab to the first pole;
wherein the first transfer sheet having a first surface and a second surface oppositely, the step of welding the transfer sheet between two layers of the tab layer in the combined tab set further comprising: connecting a part of tabs of the first tab to the first surface, and connecting other part of tabs of the first tab to the second surface, such that the first transfer sheet being located between a part of tabs of the first tab and the other part of tabs of the first tab, or, connecting all tabs of the first tab to the first surface.

24. The welding method according to claim 23, wherein the cell further comprising a third cell, the third cell leading out a fifth tab and a sixth tab with opposite polarity; the step of welding the transfer sheet between two layers of the tab layer in the combined tab set further comprising: connecting a part of tabs of the fifth tab to the first surface, and connecting other part of tabs of the fifth tab to the second surface, wherein the first tab being located on one side of the first transfer sheet and the fifth tab being located on the opposite side of the first transfer sheet;
or, the cell further comprising a third cell and a fourth cell, the third cell leading out a fifth tab and a sixth tab with opposite polarity, and the fourth cell leading out a seventh tab and an eighth tab with opposite polarity; the step of welding the transfer sheet between two layers of the tab layer in the combined tab set further comprising: connecting all tabs of the fifth tab to the first surface, and connecting all tabs of the seventh tab to the second surface, or, connecting a part of tabs of the fifth tab to the first surface, connecting other part of tabs of the fifth tab and all tabs of the seventh tab to the second surface, or, connecting all tabs of the fifth tab and a part of tabs of the seventh tab to the first surface, and connecting other part of tabs of the seventh tab to the second surface, wherein the first tab being located on one side of the first transfer sheet, the fifth tab and the seventh tab being located on opposite side of the first transfer sheet.
